(19) United States
(12) Patent Application Publication
(10) Pub. No.: US 2016/0137420 A1
(43) Pub. Date: May 19, 2016

(54) An Improved Liner

(71) Applicant: Tega Industries Limited, Kolkata, West Bengal (IN)

(72) Inventors: Kaushal KISHOR, Kolkata, West Bengal (IN); Saroj Kumar ROY, Kolkata, West Bengal (IN); Imam Syed YAVER, Kolkata, West Bengal (IN); Arunlal PANIGRAHI, Kolkata, West Bengal (IN)

(21) Appl. No.: 14/897,626

(22) PCT Filed: Sep. 9, 2013
(86) PCT No.: PCT/IN2013/000545

§ 371 Date: Dec. 10, 2015

(30) Foreign Application Priority Data
Jun. 14, 2013 (IN) 711/KOL/2013

(51) Int. Cl. B65G 11/16

(52) U.S. Cl. CPC B65G 11/166

(57) ABSTRACT

A wedge shaped liner has a back portion (1) and a front portion (3). The back portion is fixed with the chute or hopper wall (8) with the help of a bracket (4). The back portion (1) and the front portion (3) are connected by a curved portion (6), adapted to be adequately flexible and capable of good heat dissipation.

### FIELD OF THE INVENTION

The present invention in general relates to the chutes and hopper liners in bulk material handling, and in particular, to a wedge shaped liner with a bolt free fixing arrangement, reinforcement in between, to control the flexibility and heat dissipation system to allow the heat generated, due to continuous vibration in the rubber to dissipate.

### BACKGROUND OF THE INVENTION

Conveyor Belts:

Conveyor belt is considered as the principal apparatus for material handling equipments, and it is also very costly. These are used to transfer materials along long lengths without change in direction. Conveyor belts move on the idler pulleys placed at regular intervals. In general, conveyor belts have two layers of varying thicknesses, with lower layer usually of higher thickness. The upper layer will be mainly a material of anti abrasion, while the lower layer takes care of impact. The chute which loads the material on to the conveyor belt is called as discharge chute. At this point of loading, the impact will be high on the conveyor, hence impact idlers will be provided in this zone to minimize the effect of impact.

Chutes:

When material has to be transferred between conveyors at different heights or between conveyors moving in different directions, chutes are used. Chutes are flat plates, arranged at different angles to transfer or guide materials.

Chute Design:

The following parameters decide the design of chute

1) Material handled

2) Size of materials

3) Percentage of fines and percentage of coarse

4) Feed Rate (TPH)

5) Moisture contents

6) Feed Machine

7) Belt width/Screen width/Feeder width

8) Belt thickness

9) Belt speed

10) Discharge Machine

Wear of Bulk Material Handling Equipments:

Mainly two types of wear can be observed in material handling equipments.

Impact wear: As the particles are not spherical, they may gouge the liner during impact. This is termed as impact wear.

Abrasion wear: Sliding abrasion is a function of pressure, friction coefficient and sliding velocity. Abrasion wear will be high in soft materials.

Wear in Chutes: Chute plates may wear out with time, if left unprotected, due to continuous flow of material on them. This wear may finally tear the plate, forming holes in chute faces, leading to leakage of material. Hence chutes have to be replaced, which will stop the production for a long time.

To avoid this, liners are used. Liners are small rectangular blocks, used as sacrificing cover for chutes. These are mechanically fastened to the chute.

Benefits of Chute Lining:

1) Facilitates repair and replacement of sliding surface

2) Means of correcting the performance of an inadequate chute

3) Avoids abrasion wear of chute

4) Reduces impact wear, noise, dust and material degradation

5) Promotes smooth flow

6) Avoids built up of material

7) Prevents Chemical Reaction or corrosion of both system and product

The liner material is decided based on the zone it is used in. Chute has three zones.

1) Primary Impact Zone: Material after leaving the conveyor hits the chute surface in this zone. Impact wear is high in this zone.

2) Secondary Impact Zone: Material after the first impact with the chute in primary impact zone hits the chute for the second time in this zone. Both impact wear and abrasion wear can be seen here.

3) Sliding zone: The further part of the chute left is sliding zone. It helps material in achieving the required velocity at the end. Abrasion wear is predominant because of high velocity.

An ideal liner should resist impact and abrasion wear, and avoid jamming, degradation and fines generation.

But the problem in the art that remains with all the liners is that the liners till now are fixed with the hopper or the chute wall by bolting the liner with the chute or the hopper wall (may or may not use the back plate). All such bolts are opened and tightened again when the liners are replaced. The whole operation involves a lot of time. Thus substantially create operational disruption and substantial maintenance time before the conveyor belt can be brought back in action.

Thus there is a long felt need in the art of a blot free chute liner which will be easy to engage and disengage during maintenance, thereby substantially reducing the stoppage time after which the conveyor belt can be brought to operation.

The liners existing in the art are used to protect the chute or the hopper wall. The jamming of chute or the hopper is cleared using additions means. The reinforcement in the liners can solve this problem so that no such additional means is needed thereafter.

The present invention meets the aforesaid long felt needs and other needs associated therewith.

### OBJECTS OF THE INVENTION

The principal object of the present invention is to provide a chute or hopper liner with a bolt free fixing arrangement which is attached bolt free to the chute and/or hopper wall.

It is another object of the present invention to provide a chute or hopper liner which is easy to install and de-install from the chute and/or hopper wall.

It is a further object of the present invention to provide a chute or hopper liner which comprises of an elastomeric material that provides the required flexibility and good heat dissipation.

It is yet another object of the present invention to provide a chute liner or hopper liner which because of its easy installation and de-installation process saves substantial maintenance time of the conveyor belt during such change.

It is another object of the present invention to provide a chute or hopper liner which prevents jamming of materials on chute surface.

How the above objects are achieved and other advantageous features still not disclosed in the prior art would be clear from the following non-limiting description of the invention.

All through the specification, including the claims, the words “chute”, “hopper”, “conveyor”, “belt”, “liner”, “bulk material”, “abrasion”, “wear”, “bolt”, “bracket” and “springs” are to be interpreted in the broadest sense of the respective terms, and includes all similar items in the field known by other terms, as may be clear to persons skilled in art. Restriction or limitation if any referred to in the specification, is solely by way of example and understanding the present invention.

### SUMMARY OF INVENTION

Accordingly, the present invention provides a wedge shaped liner having a back portion and a front portion, the back portion is fixed with the chute or hopper wall with the help of a bracket and the back portion and the front portion are connected by a curved portion, adapted to be adequately flexible and capable of good heat dissipation.

In accordance with preferred embodiments of the liner of the present invention:
the curved portion is made of elastomeric material and the bracket comprises of a heat dissipation system to dissipate the heat generated due to continuous flexing along the curved portion of the liner,
the liner comprises of reinforcement in between the liner body to control the flexibility of the liner to clear jams in the hoppers and/or chutes,
back side of the liner is adapted to be fixed to the inner side of the bracket either by a push fit and/or a clip fixing into the bracket,
the liner is in contact with a metal part placed along the inner curve of the liner, for dissipating the excess heat generated due to continuous flexing of the liner,
the bracket has a metal part with which the liner is in contact with for dissipating the excess heat generated due to continuous flexing of the liner,
the bracket comprises of tapered walls along three faces for matching with corresponding tapered faces of the liner wall,
the bracket assembly is bolted on the chute wall in a two dimensional array covering the chute or hopper wall.

### BRIEF DESCRIPTION OF THE ACCOMPANYING DRAWINGS

Having described the main features of the invention above, a more detailed and non-limiting description of a preferred embodiment will be given in the following paragraphs with reference to the drawings, in which

FIG. 1a is the perspective view of the said chute liner fixing arrangement according to the present invention.

FIG. 1b is the side view of the said chute liner fixing arrangement according to the present invention, indicating the reinforcement.

FIG. 2a is the perspective view of the array of said chute liner fixing arrangement according to the present invention.

FIG. 2b is the front view of the array of said chute liner fixing arrangement according to the present invention.

FIG. 3a is the side view of the said liner according to the present invention.

FIG. 3b is the back view of the said liner according to the present invention.

FIG. 3c is the perspective view of the said liner according to the present invention.

FIGS. 4a, 4b and 4c are the front, top and bottom view of the bracket of chute liner fixing arrangement according to the present invention.

FIGS. 5a and 5b shows the perspective views of the liner in fixed position inside bracket.

### DETAILED DESCRIPTION OF THE INVENTION

The following provides a detailed non-limiting description of a preferred embodiment of the present invention which is purely exemplary.

The present invention presents a bolt free fixing arrangement of the liners. It consists of a bracket which is one time bolted to the chute or the hopper wall. The liners are fixed either by push fit or a clipping arrangement of the liner with the said bracket. In case of replacement of the liners, the old liners are simply pushed out of the bracket and the new liners are pushed back into the bracket.

Preferably, the present invention of bolt free liner also consists of reinforcement in between the liner body. This reinforcement is used to control the flexibility of the liner and hence can be used to clear jams in the hoppers and the chutes.

The chute liner is fixed to the chute wall either by a push fit or a clip fixing into a bracket. The liner is made of any material used for making liners presently such as rubber, poly urethane, metals etc. A bracket is used in the chute liner fixing arrangement which has tapered walls along three faces except for the one flushing with the chute or the hopper wall.

The liner as disclosed in the present invention is in contact with a metal part either attached with the said bracket or separately placed along the length of the inner curve of the liners. This part dissipates the excess heat generated due to continuous vibration of the liner.

Further the liner as in the present invention is provided with reinforcements designed such that it helps in clearing the jam in the chute or the hopper.

The reinforcement is designed such that it bends in case of jammed chute or a hopper and stretches back to its original position as soon as the wall of the chute or the hopper is opened, decreasing the force on the liners.

The crux of the invention lies in a wedged shaped liner having a front portion and back portion. The back portion is fixed with the chute or hopper wall with the help of a bracket and the back portion and the front portion are connected by a curved portion, adapted to be adequately flexible and capable of good heat dissipation. The curved portion is made of elastomeric material and the bracket comprises of a heat dissipation system to dissipate the heat generated due to continuous flexing along the curved portion of the liner. The curved portion provides the required flexibility, keeping the stress concentration below the limiting stress concentration.

The liner also comprises of reinforcement in between the liner body to control the flexibility of the liner to clear jams in the hoppers and/or chutes.

Hence, there is a bolt free fixing arrangement, reinforcement in between, to control the flexibility and heat dissipation system to allow the heat generated due to continuous vibration in the rubber to dissipate. The wedge shape reduces the impact force on the liners, the boltless fixing decreases the replacement time of the liners and the controlled flexibility is used to clear the material, in case the chutes and hoppers get jammed.

Now the invention will be more clear from the following description with reference to the drawings.

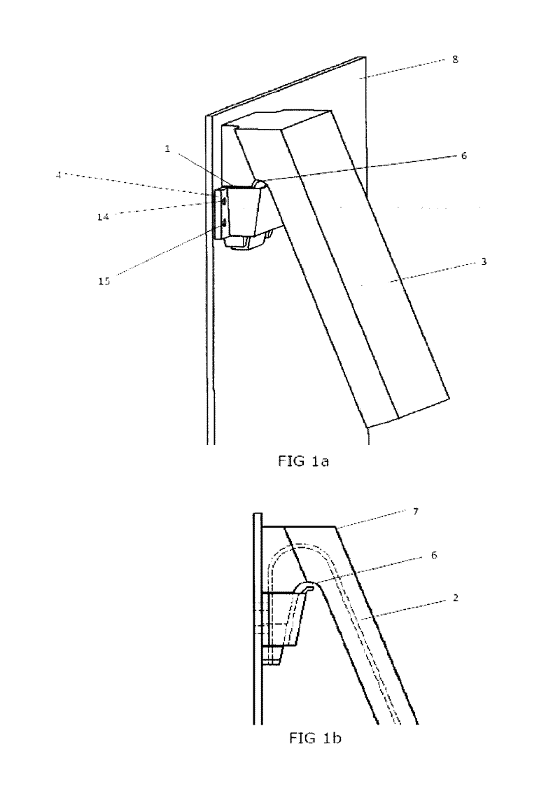

FIG. 1a, indicates the boltless chute liner fixing arrangement (1). FIG. 1b indicates the side view showing the reinforcement in the liner body (2). The back part (1) is the part of the liner which is in contact with the bracket (4) and the chute or the hopper wall (8). The front face (3) of the liner comes in direct contact with the falling materials in the chute or hopper. This is the largest part of the liner. Its dimensions are decided by the operation conditions and the area of use. The front face takes the impact of falling material. The liner is simply fitted in to the bracket portion (4) in a boltless manner.

The reinforcement (2) in the liner body is used to control the flexibility of the liner. The flexibility of the liner is controlled so as to remain bended at higher load (when chute or the hopper is filled with material) and flexes back at a lesser load (when the chute or the hopper gate is opened and materials are cleared partially). The reinforcement may be of any metal used to make springs presently such as EN42, EN45, etc.

There is a presence of curved surface (6) at the head (7) of the liner. This curvature (6) is responsible for the V shape of the liner. The back portion (1) of the liner is used to fix the liner body with the chute or the hopper wall. This curved surface (6) connects the front portion (3) and the back portion (2) of the liner.

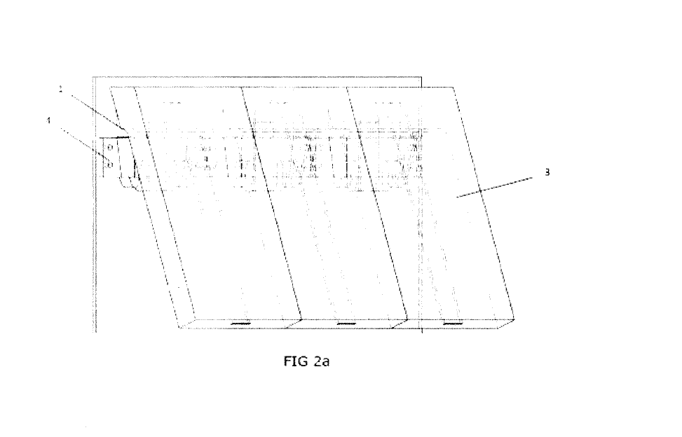

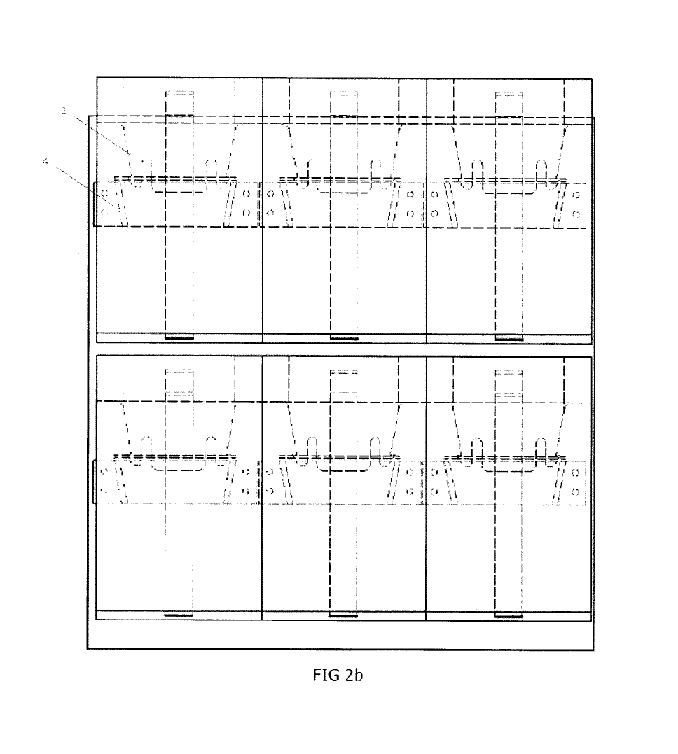

FIGS. 2(a), 2(b) show the array of arrangement of the fixing arrangement and the liner assembly. The array is such that all the front faces (3) flush with each other along the horizontal axis. Along the vertical axis the array is such that the movement of the top liner does not collide with the bottom liner.

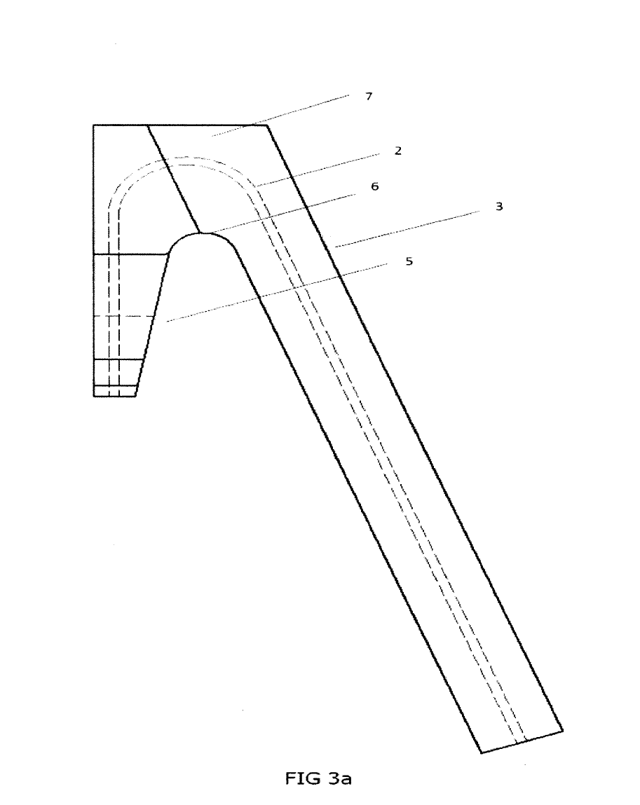

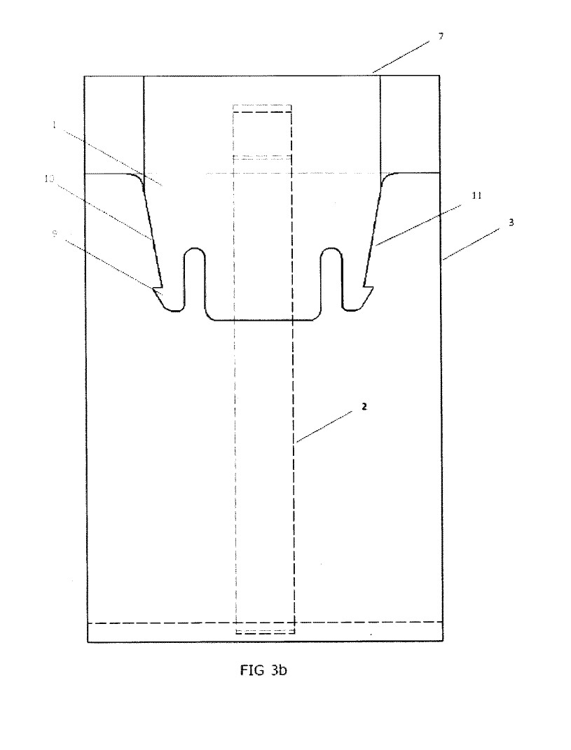

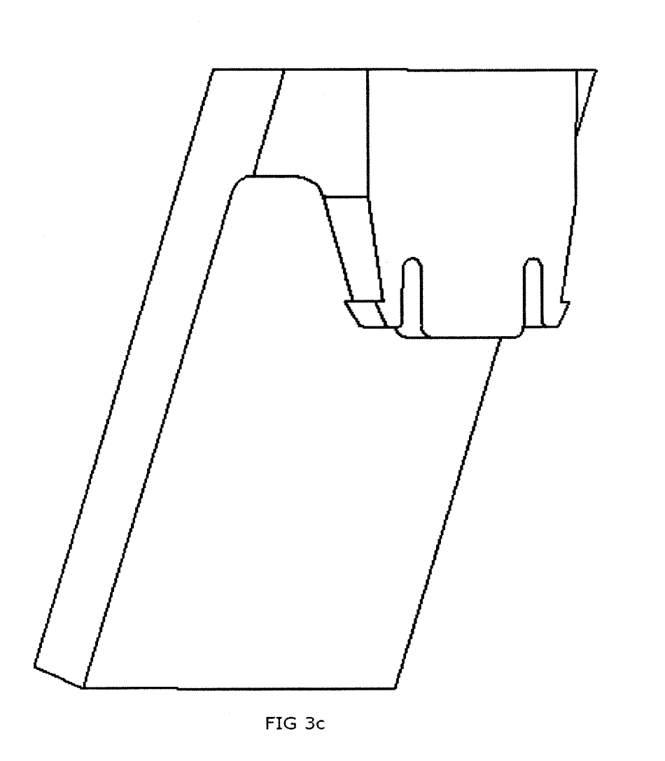

FIGS. 3(a), 3(b), 3(c) show the side, back and perspective view of the said liner respectively. As shown in the said figures the liner present tapered faces (5, 10 and 11) of the fixing portion (1) which helps in proper affixing of said liner to the bracket (4). These are responsible for the push fit of the said fixing arrangement. As shown in FIG. 3b, the end profile of tapered portion if said liner, presents a clip arrangement (9) that is present for better locking of the liners into the bracket (4).

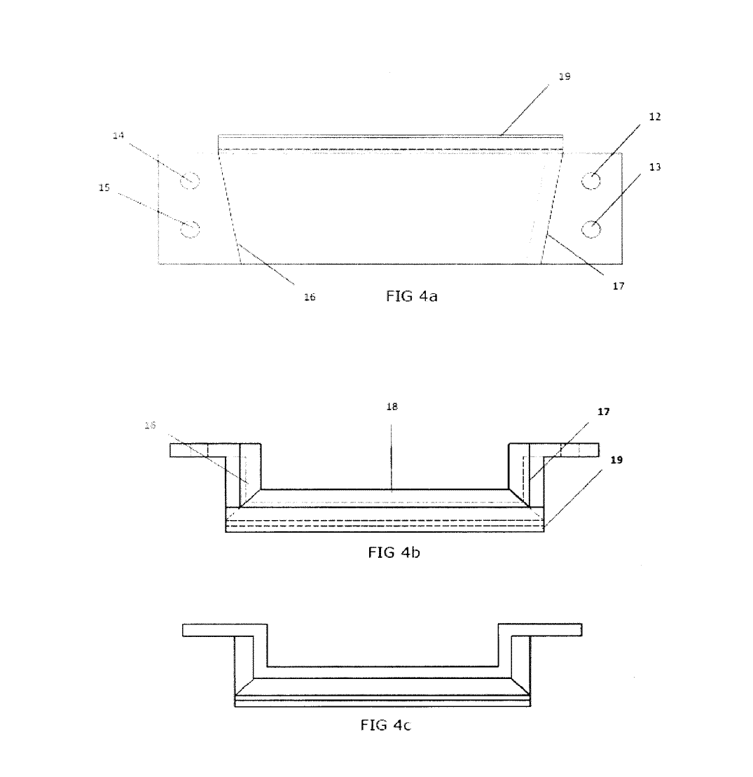

FIGS. 4a, 4b and 4c represent the front, top and bottom view of the said bracket (4). The holes (12, 13, 14 and 15) in the bracket (4) are used to bolt the bracket (4) with the Chute or the hopper wall (8). The said bracket has matching tapered walls (16, 17 and 18) with the liner along the three sides except for the side flushing with the chute or the hopper wall. These tapering are essential for the push fitting of the liner into the bracket. The said bracket has a prolonged feature (19), such as a metal part, which comes in contact with the curve (6) of liner and dissipates any heat developed due to continuous vibration in the liner.

Alternatively, this metal part (19) is present along the length of the inner curve (6) of the liners (1).

The back portion (1) of the liner, having the said fixing arrangement, is smaller in dimension compared to the front portion (3). The said back portion (1) is smaller in the horizontal direction as compared to the front portion (3). The said back portion (1) is also smaller along the length as compared to the front portion (3).

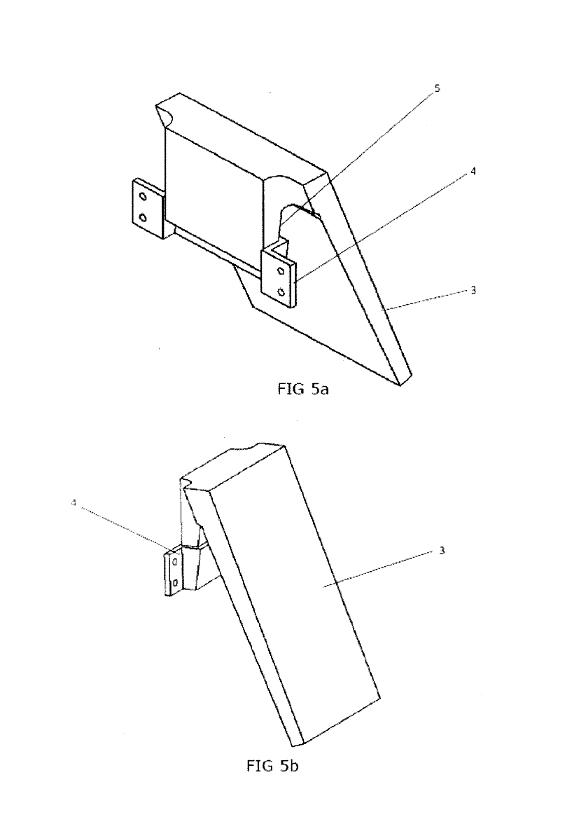

FIGS. 5a and 5b show the perspective views of the liner in fixed position inside the bracket (4) presented without the chute and hopper wall for a better view of the fixing arrangement. The tapered portion (5) moving into the bracket (4) for locking is made clearly visible in the FIG. 5a. The liner is hammered from the top. The liner is commonly made of rubber. Hence, it gets stuck in the bracket due to the tapering made in the inner surface of the back portion. During operations the force on the liner is from the above, hence the liner remains in its position. At the time of removing, the liner is hammered from below to push out of the bracket.

The above mentioned arrangements are advantageous in two ways:
1. Proper alignment of all of the liners. Hence the liner assembly is uniform.
2. An additional locking to ensure proper fixing and no chance of liner coming out due to any rebounding forces.

Some of the other non-limiting advantages of the present invention are as follows:
1) The time of installation is reduced, which is the biggest cost advantage from customer point of view. This is because during the liner replacement, the conveyor has to be shut down leading to a high cost to the customer. On an average, the liner replacement process takes 2-3 hours for a 1000×500 wall. With embodiment of the present invention it can be done in 20-30 minutes. Thus the customer's shut down loss is reduced by 80%.
2) Removes the need of any other mean to clear jams in the chute or the hoppers. This is again a very big advantage for the customers because they use high cost equipments to clear the jams. If the liners itself can solve this problem, the cost of such equipments as well as the time to perform such operations is reduced.
3) The weight of the whole product reduced due to removal of bolts.
4) The cost of the whole product reduced due to removal of bolts.

The present invention has been described with reference to the preferred embodiment and drawings for the sake of understanding only and it should be clear to persons skilled in the art that the present invention includes all legitimate modifications within the ambit of what has been described hereinbefore and claimed in the appended claims.

1. A wedge shaped liner having a back portion and a front portion, the back portion is fixed with the chute or hopper wall with the help of a bracket and the back portion and the front portion are connected by a curved portion, adapted to be adequately flexible and capable of good heat dissipation.

2. The liner as claimed in claim 1 wherein the curved portion is made of elastomeric material and the bracket comprises of a heat dissipation system to dissipate the heat generated due to continuous flexing along the curved portion of the liner.

3. The liner as claimed in claim 1, wherein the liner comprises of reinforcement in between the liner body to control the flexibility of the liner to clear jams in the hoppers and/or chutes.

4. The liner as claimed in claim 1, wherein back side of the liner is adapted to be fixed to the inner side of the bracket either by a push fit and/or a clip fixing into the bracket.

5. The liner as claimed in claim 1, wherein the liner is in contact with a metal part placed along the inner curve of the liner, for dissipating the excess heat generated due to continuous flexing of the liner.

6. The liner as claimed in claim 2, wherein the bracket has a metal part with which the liner is in contact with for dissipating the excess heat generated due to continuous flexing of the liner.

7. The liner as claimed in claim 1, wherein the bracket comprises of tapered walls along three faces for matching with corresponding tapered faces of said liner wall.

8. The liner as claimed in claim 1, wherein the bracket assembly is bolted on the chute wall in a two dimensional array covering the chute or hopper wall.
